(19) United States
(12) Patent Application Publication
(10) Pub. No.: US 2009/0247272 A1
(43) Pub. Date: Oct. 1, 2009

(54) Gaming Machine With Feature Concept And Playing Method Thereof

(75) Inventor: Fumiya Abe, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Gaming America, Inc., Las Vegas, NV (US)

(21) Appl. No.: 12/412,804

(22) Filed: Mar. 27, 2009

Related U.S. Application Data
(60) Provisional application No. 61/041,357, filed on Apr. 1, 2008.

(51) Int. Cl. A63F 9/24; A63F 13/00

(52) U.S. Cl. 463/20; 463/25; 463/30

(57) ABSTRACT

A gaming machine 1 of the present invention has a lower image display panel 16 which arranges symbols 180 in a matrix 156, and a mother board 40. The gaming machine 1 performs a base game and a plurality of feature games using the lower image display panels 16. The mother board 40: rearranges the symbols 180 in the matrix 156 in the base game; awards a base payout in accordance with a relation among the symbols 180 rearranged in the matrix 156; awards a feature game which corresponds to the number of symbols 180 of “SUN” 181 rearranged in the matrix 156; performs the feature game; and awards a bonus payout in accordance with a result of the feature game.

### CROSS REFERENCE TO RELATED APPLICATION

This application claims the benefit of U.S. Provisional Application No. 61/041,357, filed on Apr. 1, 2008 which application is incorporated herein by reference in its entirety.

### BACKGROUND OF THE INVENTION

1. Field of the Invention

The present invention relates to a gaming machine and a playing method thereof.

2. Description of Related Art

Conventionally, a gaming machine, which uses a coin or the like as a game value for a slot machine, a roulette game machine, a card game machine or the like, is capable of starting a predetermined game upon player's insertion of a coin into the gaming machine. When the player wins the game, a predetermined number of coins are paid out. Generally, in the above-mentioned gaming machine, pluralities of kinds of games are performed in order to avoid monotony. For example, when a predetermined condition is satisfied in a first game which is a base game, the first game is followed by a second game which is a so-called feature game (bonus game, free game, or the like). Conventional gaming machines of this type are disclosed in specifications of U.S. Pat. Nos. 5,820,459, 4,283,709, and 6,003,013, for example. In addition, United States Patent Application Publication No. 2002002584 discloses a free game as a second game. Here, the number of free games is determined at random, or alternatively is set to a certain number.

However, in the above-described gaming machines which perform a game including the first and second games, contents of the second game may be uniform and monotonous.

An object of the present invention is to provide a gaming machine with entertainmentness unobtainable from the above-described prior art, and a playing method thereof. More specifically, an object of the present invention is to provide a gaming machine which can provide many kinds of second games and executes different second games depending on a result of a first game. This allows a player of the gaming machine to play the first game while expecting a plurality of kinds of second games.

### SUMMARY OF THE INVENTION

The present invention provides a gaming machine comprising: a display which arranges a plurality of symbols in a matrix of arrangement areas; and a controller; wherein the gaming machine performs a base game and a plurality of feature games using the display, and wherein the controller is programmed to perform the steps of: (a1) rearranging the plurality of symbols in the arrangement areas in the base game; (a2) awarding a base payout in accordance with a relation among the symbols rearranged in the arrangement areas; (a3) awarding a feature game which corresponds to the number of predetermined symbols rearranged in the arrangement areas; (a4) performing the feature game; and (a5) awarding a bonus payout in accordance with a result of the feature game.

According to the above structure, it is possible to: award a feature game which corresponds to the number of predetermined symbols rearranged in the arrangement areas; perform the feature game; and award a bonus payout in accordance with a result of the feature game. As a result, which kind of feature game is awarded depends on the number of predetermined symbols arranged in the arrangement areas on the display. This may allow a player to enjoy the base game with expectation for a plurality of kinds of feature games until symbols are arranged in the arrangement areas on the display.

In the above-mentioned gaming machine, the controller awards a feature game whose expected value of the bonus payout differs in correspondence with to the number of predetermined symbols rearranged in the arrangement areas.

According to the above structure, feature games having different expected values of the bonus payout can be given in correspondence with the number of predetermined symbols rearranged in the arrangement areas. Therefore, for example, by setting a feature game having a higher expected value of the bonus payout as the number of predetermined symbols arranged in the arrangement areas on the display increases, a player may enjoy a feature game providing a higher payout in proportion to the number of predetermined symbols arranged in the arrangement areas on the display.

The present invention provides a gaming machine comprising: a display which arranges a plurality of symbols in a matrix of arrangement areas; and a controller; wherein the gaming machine performs a base game using the display and a plurality of feature games each corresponding to the number of predetermined symbols arranged in the arrangement areas, and wherein the controller is programmed to perform the steps of: (b1) rearranging the plurality of symbols in the arrangement areas in the base game; (b2) awarding a base payout in accordance with a relation among the symbols rearranged in the arrangement areas; (b3) randomly changing a correspondence between the number of predetermined symbols and a feature game; (b4) awarding a feature game which corresponds to the number of predetermined symbols rearranged in the arrangement areas; (b5) performing the feature game; and (b6) awarding a bonus payout in accordance with a result of the feature game.

According to the above structure, it is possible to: randomly change correspondence between the number of predetermined symbols and the feature game; award a feature game corresponding to the number of predetermined symbols rearranged in the arrangement areas; perform the feature game; and award a bonus payout in accordance with a result of the feature game. As a result, a kind of the feature game, which is given based on the number of predetermined symbols arranged in the arrangement areas on the display, changes every time a base game is executed. A player cannot know which feature game will be executed until the feature game is actually executed. Therefore, the player may enjoy the base game with expectation for a plurality of kinds of feature games.

In the above-mentioned gaming machine, an expected value of the bonus payout which is in accordance with the result of the feature game differs depending on a kind of the feature game.

According to the above structure, it is possible that an expected value of the bonus payout which is in accordance with the result of the feature game differs depending on a kind of the feature game. As a result, a kind of the feature game, which is given based on the number of predetermined symbols arranged in the arrangement areas on the display, changes every time a base game is executed. A player cannot know which feature game will be executed until the feature game is actually executed. Therefore, the player may enjoy the high-payout feature game even when the number of predetermined symbols arranged in the arrangement areas on the display is small.

The present invention provides a gaming machine comprising: a display which arranges a plurality of scatter symbols in a matrix of arrangement areas; and a controller, wherein the gaming machine performs a base game and a plurality of feature games using the display, and wherein the controller is programmed to perform the steps of: (c1) rearranging the plurality of scatter symbols in the arrangement areas in the base game; (c2) awarding a base payout in accordance with a relation among the scatter symbols rearranged in the arrangement areas; (c3) awarding a feature game which corresponds to the number of predetermined scatter symbols rearranged in the arrangement areas; (c4) performing the feature game; and (c5) awarding a bonus payout in accordance with a result of the feature game.

According to the above structure, it is possible to: award a feature game which corresponds to the number of predetermined scatter symbols rearranged in the arrangement areas; perform the feature game; and award a bonus payout in accordance with a result of the feature game. As a result, which kind of feature game is awarded depends on the number of predetermined scatter symbols arranged in the arrangement areas on the display. This may allow a player to enjoy the base game with expectation for a plurality of kinds of feature games until symbols are arranged in the arrangement areas on the display.

In the above-mentioned gaming machine, the controller awards a feature game whose expected value of the bonus payout differs in correspondence with to the number of predetermined scatter symbols rearranged in the arrangement areas.

According to the above structure, feature games having different expected values of the bonus payout can be given in correspondence with the number of predetermined scatter symbols rearranged in the arrangement areas. Therefore, for example, by setting a feature game having a higher expected value of the bonus payout as the number of predetermined scatter symbols arranged in the arrangement areas on the display increases, a player may enjoy a feature game providing a higher payout in proportion to the number of predetermined scatter symbols arranged in the arrangement areas on the display.

The present invention provides a gaming machine comprising: a display which arranges a plurality of scatter symbols in a matrix of arrangement areas; and a controller, wherein the gaming machine performs a base game using the display and a plurality of feature games each corresponding to the number of predetermined scatter symbols arranged in the arrangement areas, and wherein the controller is programmed to perform the steps of: (d1) rearranging the plurality of scatter symbols in the arrangement areas in the base game; (d2) awarding a base payout in accordance with a relation among the scatter symbols rearranged in the arrangement areas; (d3) randomly changing a correspondence between the number of predetermined scatter symbols and a feature game; (d4) awarding a feature game which corresponds to the number of predetermined scatter symbols rearranged in the arrangement areas; (d5) performing the feature game; and (d6) awarding a bonus payout in accordance with a result of the feature game.

According to the above structure, it is possible to: randomly change correspondence between the number of predetermined scatter symbols and the feature game; award a feature game corresponding to the number of predetermined scatter symbols rearranged in the arrangement areas; perform the feature game; and award a bonus payout in accordance with a result of the feature game. As a result, a kind of the feature game, which is given based on the number of predetermined scatter symbols arranged in the arrangement areas on the display, changes every time a base game is executed. A player cannot know which feature game will be executed until the feature game is actually executed. Therefore, the player may enjoy the base game with expectation for a plurality of kinds of feature games.

In the above-mentioned gaming machine, an expected value of the bonus payout which is in accordance with the result of the feature game differs depending on a kind of the feature game.

According to the above structure, it is possible that an expected value of the bonus payout which is in accordance with the result of the feature game differs depending on a kind of the feature game. As a result, a kind of the feature game, which is given based on the number of predetermined scatter symbols arranged in the arrangement areas on the display, changes every time a base game is executed. A player cannot know which feature game will be executed until the feature game is actually executed. Therefore, the player may enjoy the high-payout feature game even when the number of predetermined scatter symbols arranged in the arrangement areas on the display is small.

The present invention provides a playing method of a gaming machine which comprises a display for arranging a plurality of symbols in a matrix of arrangement areas, and which performs a base game and a plurality of feature games using the display, the method including the steps of: rearranging the plurality of symbols in the arrangement areas in the base game; awarding a base payout in accordance with a relation among the symbols rearranged in the arrangement areas; awarding a feature game which corresponds to the number of predetermined symbols rearranged in the arrangement areas; performing the feature game; and awarding a bonus payout in accordance with a result of the feature game.

According to the above-mentioned playing method, it is possible to: award a feature game which corresponds to the number of predetermined symbols rearranged in the arrangement areas; perform the feature game; and award a bonus payout in accordance with a result of the feature game. As a result, which kind of feature game is awarded depends on the number of predetermined symbols arranged in the arrangement areas on the display. This may allow a player to enjoy the base game with expectation for a plurality of kinds of feature games until symbols are arranged in the arrangement areas on the display.

### BRIEF DESCRIPTION OF THE DRAWINGS

FIG. 1 is an explanatory view showing a playing method of a gaming machine;

FIG. 2 is a block diagram of the gaming machine;

FIG. 3 is a perspective view showing external appearance of a gaming machine;

FIG. 4 is a block diagram showing an electrical structure of the gaming machine;

FIG. 5 is an explanatory view showing a base game winning combination lottery table;

FIG. 6 is an explanatory view showing a base game payout table;

FIG. 7 is an explanatory view showing a feature game payout table;

FIG. 8 is an explanatory view showing a display screen during a base game;

FIG. 9 is an explanatory view showing a display screen of GAME A (shooting game);

FIG. 10 is an explanatory view showing a display screen of GAME B (football game);

FIG. 11 is an explanatory view showing a display screen of GAME C (baseball game);

FIG. 12 shows symbol columns and code numbers of respective symbols;

FIG. 13 is a flowchart of a boot process which is executed in the gaming machine;

FIG. 14 is a flowchart of an initial process which is executed in the gaming machine;

FIG. 15 is a flowchart of a game running process which is executed in the gaming machine; and

FIG. 16 is a flowchart of a game running process which is executed in the gaming machine.

### DESCRIPTION OF THE PREFERRED EMBODIMENTS

An embodiment of a gaming machine and a playing method thereof according to the present invention will be described.

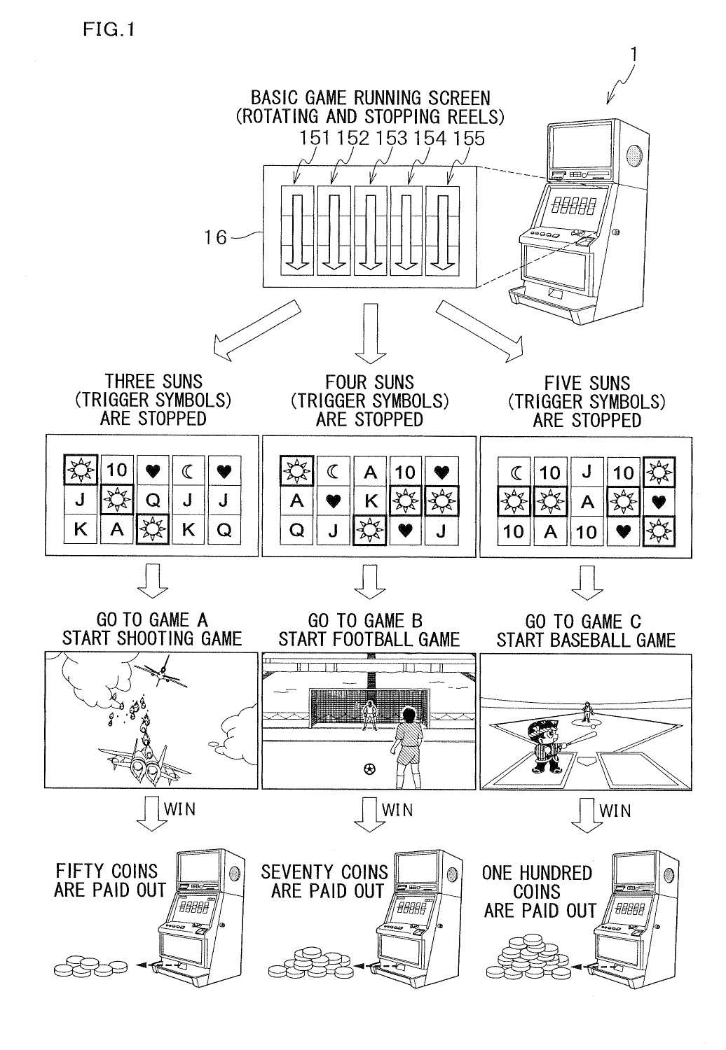

As shown in FIG. 1, the present invention is a gaming machine including: a display which arranges a plurality of symbols in a matrix of arrangement areas; and a controller. The gaming machine performs a base game and a plurality of feature games using the display. The present invention is embodied as a playing method of the gaming machine, including the steps of: rearranging the plurality of symbols in the arrangement areas in the base game; awarding a base payout in accordance with a relation among the symbols rearranged in the arrangement areas; awarding a feature game which corresponds to the number of predetermined symbols rearranged in the arrangement areas; performing the feature game; and awarding a bonus payout in accordance with a result of the feature game.

Here, “arranging” means making a state where symbols 180 are visible to a player. For example, in FIG. 1, it means making a state where symbols 180 are displayed in display windows 151 to 155. Arranging symbols 180 again after dismissing symbols 180 is called “rearranging”.

The “feature game” in this embodiment provides a game state which is more advantageous than in the base game. No particular limitation is put on the feature game, as long as it is more advantageous than the base game. For example, it may be a state where more game values are obtainable than in the base game, where game values can be obtained with a higher probability than in the base game, where game values are less consumed than in the base game, or the like. In this embodiment, a mini-game such as “GAME A”, “GAME B”, and “GAME C” which will be detailed later are mentioned as the feature game.

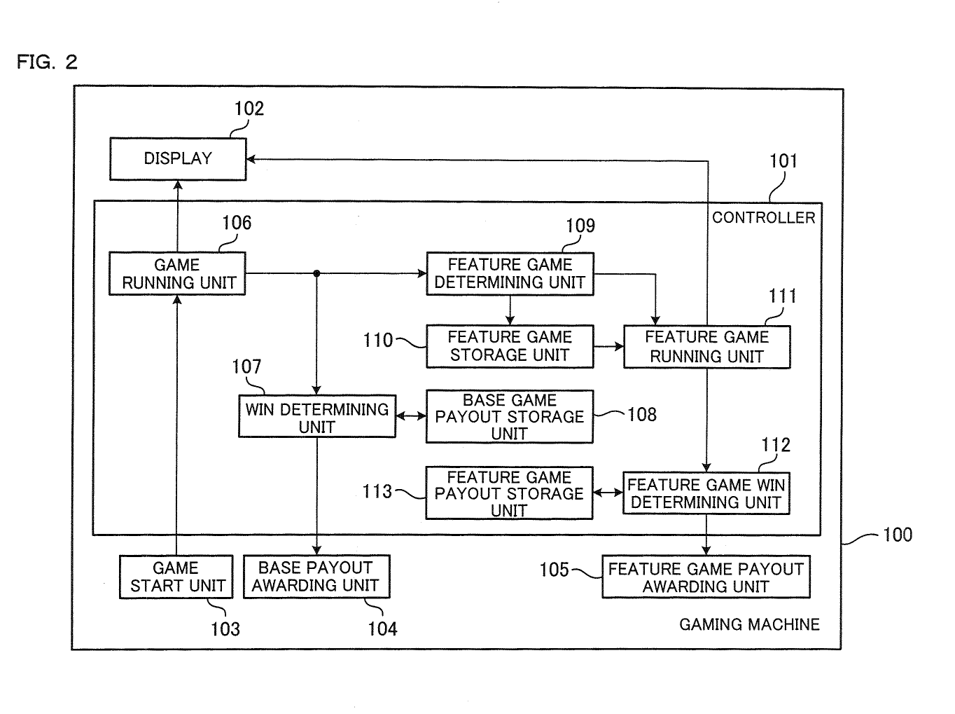

A gaming machine 100 which performs the above game has a controller 101, a display 102, a game start unit 103, a base payout awarding unit 104, and a feature game payout awarding unit 105, as shown in FIG. 2. The display 102 is adapted to arrange symbols 180.

The display 102 may have a mechanical structure adopting a reel device which rotates a reel to arrange symbols 180. Alternatively, the display 102 may have an electrical structure in which a video reel is displayed as an image to thereby arrange symbols 180. Further, a combination of the mechanical structure (reel) and the electric structure (video reel) may also be possible. Examples of the electrical structure include a liquid crystal display device, a CRT (cathode-ray tube), a plasma display device, and the like. A specific structure of the display 102 will be detailed later.

The controller 101 has a game running unit 106, a winning determining unit 107, a base game payout storage unit 108, a feature game determining unit 109, a feature game storage unit 110, a feature game running unit 111, a feature game win determining unit 112, and a feature game payout storage unit 113.

[Process Stages of Controller 101]

The controller 101 is adapted to perform: a first process of rearranging a plurality of symbols in arrangement areas in the base game; a second process of awarding a base payout in accordance with a relation among the symbols rearranged in the arrangement areas; a third process of awarding a feature game which corresponds to the number of predetermined symbols rearranged in the arrangement areas; a fourth process of performing the feature game; and a fifth process of awarding a bonus payout in accordance with a result of the feature game. In other words, the controller 101 includes five process stages.

[Operations of Controller 101]

Operations of the controller 101 having the above-described structure will be described. First, after a game value is inserted, triggered by a game start signal from the game start unit 103, the game running unit 106 starts to variably display the symbols 180 which have been arranged on the display 102. In short, the controller 101 performs the first process.

Then, the winning determining unit 107 refers to a payout table stored in the base game payout storage unit 108, and causes the base payout awarding unit 104 to award a base payout in accordance with a relation among the symbols 180 rearranged on the display 102. In short, the controller 101 performs the second process.

Then, the feature game determining unit 109 determines the number of symbols 180 of “SUN” 181 rearranged on the display 102. The feature game determining unit 109 refers to the feature game storage unit 110, to award a feature game (“GAME A”, “GAME B”, or “GAME C”) corresponding to the number of symbols 180 of “SUN” 181. In short, the controller 101 performs the third process.

Then, the feature game running unit 111 runs the feature game awarded in the third process. In short, the controller 101 performs the fourth process.

Then, the feature game win determining unit 112 refers to a payout table stored in the feature game payout storage unit 113, to cause the feature game payout awarding unit 105 to award a bonus payout in accordance with a result of the feature game. In short, the controller 101 performs the fifth process.

Each block of the controller 101 may be formed by hardware or by software as needed.

As seen from the above-described operations, the present invention is a gaming machine 100 including: a display 102 which arranges a plurality of symbols 180 in a matrix of arrangement areas; and a controller 101. The gaming machine 100 performs a base game and a plurality of feature games using the display 102. The present invention is embodied as a playing method of the gaming machine 100, including the steps of: rearranging the plurality of symbols 180 in the arrangement areas in the base game; awarding a base payout in accordance with a relation among the symbols 180 rearranged in the arrangement areas; awarding a feature game which corresponds to the number of symbols 180 of “SUN” 181 rearranged in the arrangement areas; performing the feature game; and awarding a bonus payout in accordance with a result of the feature game.

In the above-described structure, it is possible to: award a feature game which corresponds to the number of symbols 180 of “SUN” 181 rearranged in the arrangement areas; perform the feature game; and award a bonus payout in accordance with a result of the feature game. As a result, which kind of feature game is awarded depends on the number of symbols 180 of “SUN” 181 arranged in the arrangement areas on the display 102. This may allow a player to enjoy the base game with expectation for a plurality of kinds of feature games until symbols 180 are arranged in the arrangement areas on the display 102.

### Embodiment

[Mechanical Structure of Gaming Machine]

The following describes an embodiment where the gaming machine 100 having the above-described structure is applied to a gaming machine 1 and specifically structured in mechanical, electrical, and operational senses.

The gaming machine 1 is placed in a gaming facility or the like. The gaming machine 1 performs a unit game by use of a game value. The game value is a coin, a bill, or a value in the form of electronic information. However, the game value in the present invention is not particularly limited. For example, a medal, token, electronic money, a ticket and the like are also possible. Further, the ticket is not particularly limited and may be a barcoded ticket which will be described later, and the like.

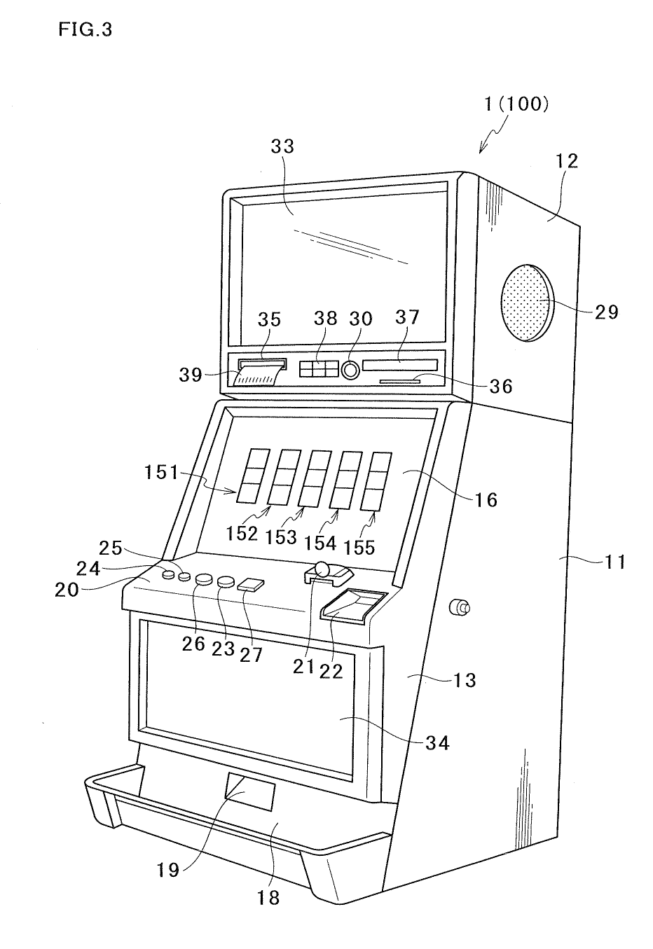

As shown in FIG. 3, the gaming machine 1 has a cabinet 11, a top box 12 placed on an upper side of the cabinet 11, and a main door 13 provided on a front surface of the cabinet 11. A lower image display panel 16 is provided on the main door 13. The lower image display panel 16 has a transparent liquid crystal panel which displays various information. The lower image display panel 16 displays display windows 151 to 155 (a matrix 156) where a plurality of symbols 180 are arranged. In addition, the lower image display panel 16 displays as needed various game-related information, effect images, and the like. The gaming machine 1 corresponds to the gaming machine 100 shown in FIG. 2. The matrix 156 with five columns and three rows in the display windows 151 to 155 correspond to the matrix of arrangement areas. The lower image display panel 16 corresponds to the display 102 shown in FIG. 2.

This embodiment deals with, as an example, a case where the lower image display panels 16 electrically display symbols 180 to thereby display five columns and three rows of symbols. However, the present invention is not limited thereto. For example, three columns and three rows of symbols, or five columns and five rows of symbols, may be acceptable.

In this example, symbols 180 arranged in the display windows 151 to 155 are scatter symbols. Here, scatter symbols mean such symbols that activation occurs (i.e., a payout is awarded, a bonus game is given, a feature game is given, or the like) when a predetermined number of them stop in the matrix of arrangement areas made up of the five columns and three rows of the display windows 151 to 155. For example, in a base game where scatter symbols are adopted, a payout is awarded when a predetermined number (e.g., five or more) of scatter symbols are displayed in the display windows 151 to 155 (fifteen arrangement regions). That is, when a predetermined number of scatter symbols are displayed in the display windows 151 to 155, a payout is awarded regardless of display positions or an arrangement way of the scatter symbols.

Note that the lower image display panel 16 may have a credit value indicator and a payout value indicator. The credit value indicator displays a total value (hereinafter also referred to as total credit value) which the gaming machine 1 can pay out to a player. The payout value indicator displays the number of coins to be paid out.

Below the lower image display panel 16, a control panel 20, a coin receiving slot 21, and a bill validator 22 are provided. The control panel 20 is provided with buttons 23 to 27. These buttons 23 to 27 allow a player to input commands relating to a game progress. The coin receiving slot 21 enables coins to be received into the cabinet 11.

The control panel 20 includes a spin button 23, a change button 24, a cashout button 25, a 1-BET button 26, and a maximum BET button 27. The spin button 23 is for inputting a command to start scrolling the symbols 180. The change button 24 is used to ask a staff person of the gaming facility for money exchange. The cashout button 25 is for inputting a command to pay out coins corresponding to the total credit-value into the coin tray 18. The control panel 20 which performs a game in the gaming machine 1 corresponds to the game start unit 103 shown in FIG. 2.

The 1-BET button 26 is for inputting a command to bet, on a game, one coins among coins corresponding to the total credit value. The maximum BET button 27 is for inputting a command to bet, on a game, a maximum number of coins bettable on one game (e.g., fifty coins) among coins corresponding to the total credit value. The 1-BET button 26, the spin button 23, and the maximum BET button 27 also serve as operation buttons for various feature games which are run in a later-detailed game running process.

The bill validator 22 validates whether a bill is genuine or not and receives the genuine bill into the cabinet 11. Note that the bill validator 22 is capable of reading a barcoded ticket 39 which will be described later. When the bill validator 22 reads the barcoded ticket 39, it outputs to the main CPU 41 a read signal relating to what has been read.

On a front surface of a lower part of the main door 13, that is, below the control panel 20, a belly glass 34 is provided. On the belly glass 34, a character of the gaming machine 1 or the like is drawn. On a front surface of the top box 12 is provided an upper image display panel 33. The upper image display panel 33 has a liquid crystal panel, and displays an effect image, an image representing game introduction or game rules, or the like.

Further, the top box 12 has a lamp 30 for presenting an effect, and a speaker 29 for performing an audio output. Below the upper image display panel 33 are provided a ticket printer 35, a card reader 36, a data displayer 37, and a keypad 38. The ticket printer 35 prints, on to a ticket, a barcode which is an encoded form of data such as a credit-value, time and date, identification number of the gaming machine 1, and the like. Thereby, the ticket printer 35 issues a barcoded ticket 39. A player can play a game in other gaming machine 1 with the barcoded ticket 39, or exchange the barcoded ticket 39 with bill at a change booth of the game arcade.

The card reader 36 reads and writes data from and into a smart card. The smart card is carried by a player, and stores therein data for identifying the player and data relating to a history of games played by the player, for example.

The data displayer 37 includes a fluorescent display or the like, and displays the data read by the card reader 36 and the data input by the player through the keypad 38, for example. The keypad 38 is for entering commands or data relating to issuing of a ticket.

[Electrical Structure of Gaming Machine]

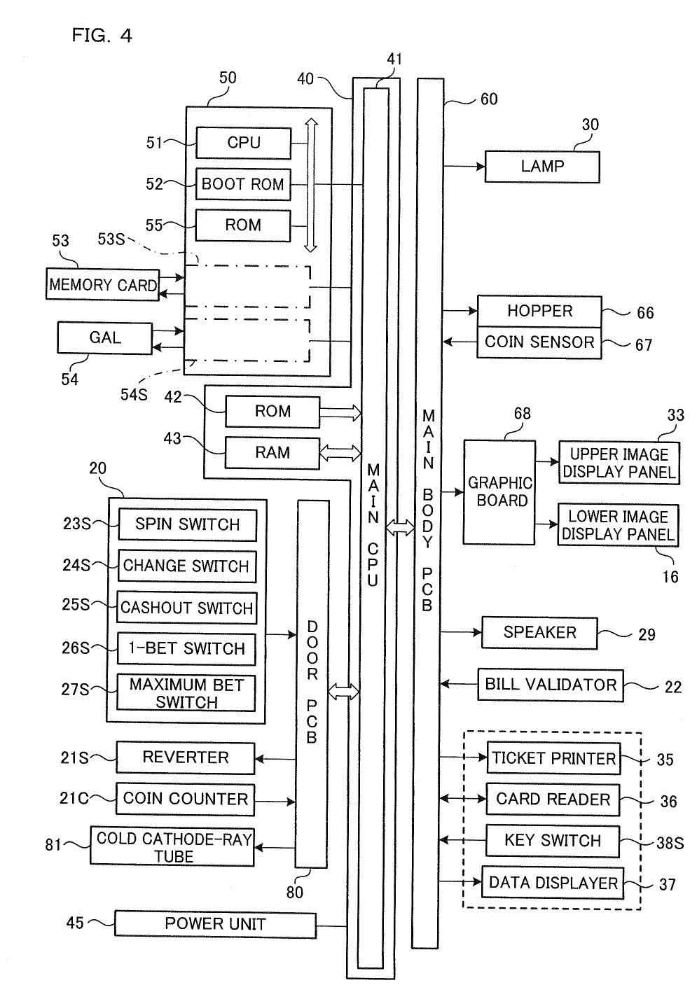

FIG. 4 is a block diagram illustrating an electrical structure of the gaming machine 1. As illustrated in FIG. 4, a control unit is provided within the cabinet 11. The control unit includes a motherboard 40, a main body PCB (Printed Circuit Board) 60, a gaming board 50, a door PCB 80, various switches, sensors, or the like.

The gaming board 50 has a CPU (Central Processing Unit) 51, a ROM 55, a boot ROM 52, a card slot 53S corresponding to a memory card 53, and an IC socket 54S corresponding to a GAL (Generic Array Logic) 54. The CPU 51, the ROM 55, and the boot ROM 52 are connected to one another through an internal bus.

The memory card 53 stores therein a game program and a game system program. The game program contains a stop symbol determining program. The stop symbol determining program determines symbols (code numbers corresponding to the symbols) to be stopped on the matrix 156.

This stop symbol determining program contains sets of symbol weighting data respectively corresponding to various payout rates (e.g., 80%, 84%, and 88%). Each set of the symbol weighting data indicates, for each of the display windows 151 to 155, correspondence between a code number of each symbol column (symbol lines A to E) and at least one random numerical value belonging to a predetermined range. The payout rate is determined based on payout rate setting data output from the GAL 54. Based on a set of the symbol weighting data corresponding to the payout rate determined, a symbol to be stopped is determined.

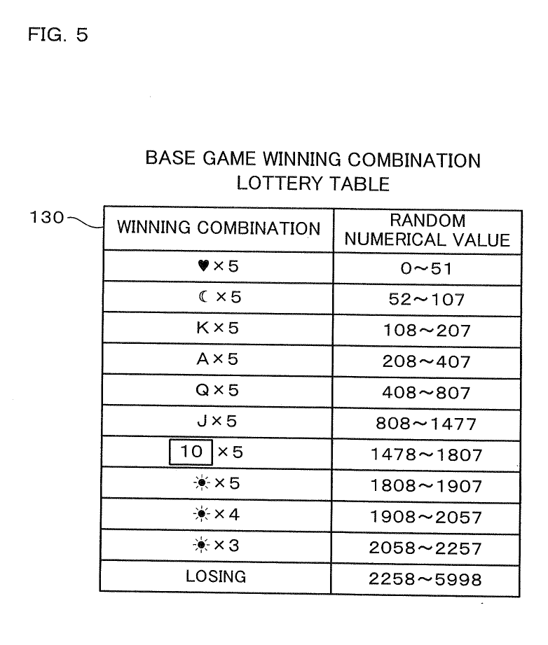

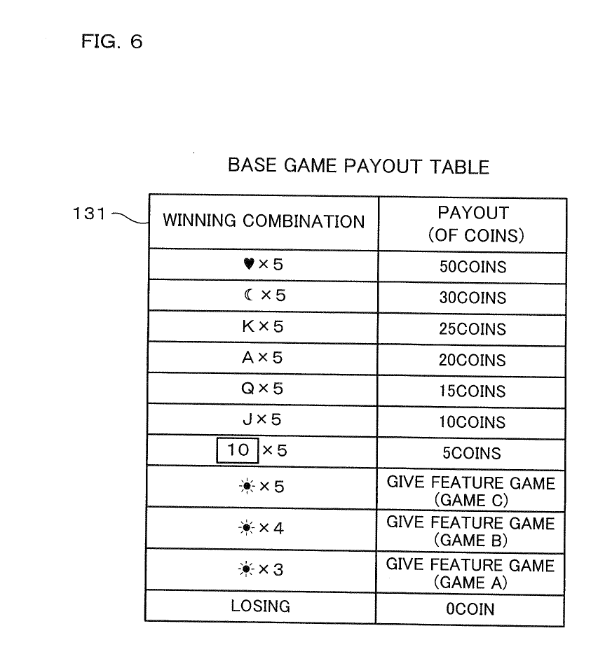

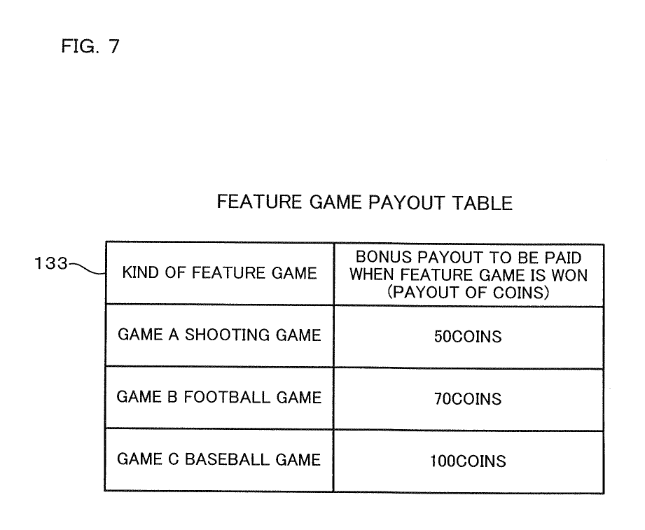

The memory card 53 stores therein various types of data for use in the game programs and the game system programs. For example, the memory card 53 stores data indicating correspondence between each of symbols 180 displayed in the display windows 151 to 155 and a range of random numerical values, in the form of a base game winning combination lottery table 130 (see FIG. 5). The memory card 53 also stores payout data which are based on a lottery result obtained from the base game winning combination lottery table 130, in the form of a base game payout table 131 (see FIG. 6). In addition, the memory card 53 stores bonus payout data which are based on a game result of a feature game, in the form of a feature game payout table 133 (see FIG. 7). These data are transferred to a RAM 43 of the motherboard 40, during a base game running processing.

The card slot 53S is structured so as to allow the memory card 53 to be attached and detached to and from the card slot 53S. This card slot 53S is connected to the motherboard 40 through an IDE bus. Thus, a type and contents of a game run by the gaming machine 1 can be changed by detaching the memory card 53 from the card slot 53S, writing a different game program and a different game system program into the memory card 53, and inserting the memory card 53 back into the card slot 53S.

The game programs include a program relating to a game progress. The game programs also include data of images and sounds to be outputted during a game.

The GAL 54 has input and output ports. When the GAL 54 receives data via the input port, it outputs, from its output port, data corresponding to the input data.

The IC socket 54S is structured so as to allow the GAL 54 to be attached and detached to and from the IC socket 54S. The IC socket 54S is connected to the motherboard 40, via a PCI bus. Thus, data to be output from the GAL 54 can be changed by detaching the GAL 54 from the IC socket 54S, overwriting the program stored in the GAL 54, and then attaching the GAL 54 back to the IC socket 54S.

The CPU 51, the ROM 55, and the boot ROM 52 connected to one another through the internal bus are connected to the motherboard 40 through a PCI bus. The PCI bus communicates signals between the motherboard 40 and the gaming board 50, and supplies power from the motherboard 40 to the gaming board 50. The ROM 55 stores country identification information and an authentication program. The boot ROM 52 stores a preliminary authentication program, a program (boot code) for enabling the CPU 51 to run the preliminary authentication program, and the like.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication program to be authenticated is not falsified, that is, for authenticating the authentication program.

The motherboard 40 has a main CPU 41, a ROM (Read Only Memory) 42, and a RAM (Random Access Memory) 43. The motherboard 40 acting as a controller corresponds to the controller 101 shown in FIG. 2.

The main CPU 41 controls the entire gaming machine 1. In particular, the main CPU 41 controls the following operations of: outputting a command signal for making the graphic board 68 variably display symbols 180, at a time when the spin button 23 is pressed after betting of credit; determining symbols 180 to be stopped after the variable-displaying of symbols 180; and stopping the symbols 180 thus determined in the display windows 151 to 155. The main CPU 41 corresponds to the game running unit 106, the winning determining unit 107, the feature game determining unit 109, the feature game running unit 111, and the feature game win determining unit 112 shown in FIG. 2.

In other words, the main CPU 41 serves to control arrangement, by scrolling symbols displayed in the lower image display panels 16, then selecting and determining symbols to be rearranged from various kinds of symbols, to rearrange new symbols, and stopping scrolling of the symbols to present the symbols thus determined.

The ROM 42 stores a program such as BIOS (Basic Input/Output System) run by the main CPU 41, and permanently-used data. When the BIOS is run by the main CPU 41, each of peripheral devices is initialized, and the game program and the game system program stored in the memory card 53 are read out through the gaming board 50.

The RAM 43 stores data or a program used for the main CPU 41 to perform a process. For example, the base game winning combination lottery table 130, the base game payout table 131, the feature game payout table 133, an initial processing program, a game running processing program, and a sidebet processing program are stored in the RAM 43. In addition, programs for running the “GAME A” (shooting game), the “GAME B” (football game), and the “GAME C” (baseball game), which are feature games to be read during the game running process, are stored in the RAM 43. Further, a credit value is stored in the RAM 43. The RAM 43 corresponds to the base game payout storage unit 108, the feature game storage unit 110, and the feature game payout storage unit 113 shown in FIG. 2.

A main body PCB (Printed Circuit Board) 60 and a door PCB 80 are connected to the motherboard 40, respectively through USBs (Universal Serial Buses). Further, a power unit 45 is connected to the motherboard 40. When the power unit 45 supplies power to the motherboard 40, the main CPU 41 of the mother board 40 is booted and in addition power is supplied to the gaming board 50 through the PCI bus so that the CPU 51 is booted.

Various devices or units which generate signals to be input to the main CPU 41, and various devices or units whose operations are controlled by signals output from the main CPU 41 are connected to the main body PCB 60 and the door PCB 80. Based on a signal input to the main CPU 41, the main CPU 41 runs the game program and the game system program stored in the RAM 43, to perform an arithmetic process. Then, the main CPU 41 stores a result of the arithmetic process in the RAM 43, or performs a control process on various devices and units by transmitting a control signal to the various devices and units.

A lamp 30, a hopper 66, a coin sensor 67, a graphic board 68, the speaker 29, a bill validator 22, a ticket printer 35, a card reader 36, a key switch 38S, and a data displayer 37 are connected to main body PCB 60.

The lamp 30 is turned on/off based on a control signal from the main CPU 41.

The hopper 66 is mounted within the cabinet 11 and pays out a predetermined number of coins through a coin outlet 19 into the coin tray 18, based on a control signal output from the main CPU 41. The coin sensor 67 is provided inside the coin outlet 19. When the coin sensor 67 senses that a predetermined number of coins have been delivered from the coin outlet 19, the coin sensor 67 outputs a signal to be input to the main CPU 41. The hopper 66 corresponds to the base payout awarding unit 104 and the feature game payout awarding unit 105 shown in FIG. 2.

The graphic board 68 controls image display on the upper image display panel 33 and the lower image display panel 16, based on a control signal from the main CPU 41. Further, the graphic board 68 is provided with a VDP (Video Display Processor) for generating image data based on a control signal output from the main CPU 41, a video RAM for temporarily storing the image data generated by the VDP, and the like. Note that image data used at the time when the VDP generates the image data are included in the game program which has been read out from the memory card 53 and stored into the RAM 43.

The bill validator 22 reads an image on a bill and takes only one recognized to be genuine into the cabinet 11. When taking in a genuine bill, the bill validator 22 outputs, to the main CPU 41, an input signal based on a value of the bill. The main CPU 41 stores into the RAM 43 a credit value equivalent to the value of the bill indicated by the signal.

Based on a control signal output from the main CPU 41, the ticket printer 35 prints a barcode on a ticket, and outputs it as a barcoded ticket 39. The barcode contains encoded data of the credit value stored in the RAM 43, time and date, an identification number of the gaming machine 1, and the like.

The card reader 36 reads out data from the smart card and transmits the data to the main CPU 41. Further, the card reader 36 writes data into the smart card based on a control signal output from the main CPU 41. The key switch 38S is mounted to the keypad 38, and outputs a signal to the main CPU 41 in response to a player's operation on the keypad 38. The data displayer 37 displays, based on a control signal output from the main CPU 41, data read by the card reader 36 or data input by the player through the keypad 38.

A control panel 20, a reverter 21S, a coin counter 21C, and a cold cathode tube 81 are connected to the door PCB 80. The control panel 20 is provided with: a spin switch 23S associated with the spin button 23; a change switch 24S associated with the change button 24; a cashout switch 25S associated with the cashout button 25; a 1-BET switch 26S associated with the 1-BET button 26; and a maximum BET switch 27S associated with the maximum BET button 27. Each of the switches 23S to 27S outputs a signal to the main CPU 41, when a player presses the associated button.

The coin counter 21C is provided within the coin receiving slot 21, and identifies whether a coin inserted into the coin receiving slot 21 by the player is genuine or not. A coin other than a genuine coin is discharged from the coin outlet 19. The coin counter 21C outputs an input signal to the main CPU 41 upon detection of a genuine coin.

The reverter 21S is operated based on control signals output from the main CPU 41. The reverter 21S distributes coins, which the coin counter 21C has recognized as genuine coins, to the hopper 66 or a cash box (not shown) mounted in the gaming machine 1. In other words, when the hopper 66 is full of coins, genuine coins are distributed into the cash box by the reverter 21S. On the other hand, when the hopper 66 is not yet full of coins, genuine coins are distributed into the hopper 66. The cold cathode tube 81 functions as a backlight mounted on rear sides of the lower image display panel 16 and the upper image display panel 33. The cold cathode tube 81 turns on based on a control signal output from the main CPU 41.

[Base Game Winning Combination Lottery Table]

A base game winning combination lottery table 130 which is used in a game running process executed in the gaming machine 1 will be described with reference to FIG. 5. FIG. 5 is an explanatory view showing a base game winning combination lottery table. The base game winning combination lottery table 130 is stored in the RAM 43, and read during a symbol determining process of the game running process which will be described later.

As shown in FIG. 5, random numerical values used in the base game winning combination lottery table 130 ranges from 0 to 5998. When a random numerical value sampled by the main CPU 41 is 0 to 51, a winning combination of “HEART” 182 is made, and five symbols 180 presenting “HEART” 182 are stopped in the display windows 151 to 155. When a random numerical value sampled by the main CPU 41 is 52 to 107, a winning combination of “MOON” 183 is made, and five symbols 180 of “MOON” 183 are stopped in the display windows 151 to 155. Likewise, when a random numerical value is 108 to 207, a winning combination of “K” 186 is made. When a random numerical value is 208 to 407, a winning combination of “A” 184 is made. When a random numerical value is 408 to 807, a winning combination of “Q” 187 is made. When a random numerical value is 808 to 1477, a winning combination of “J” 185 is made. When a random numerical value is 1478 to 1807, a winning combination of “10” 188 is made.

When a random numerical value sampled by the main CPU 41 is 1808 to 1907, a winning combination of “SUN*5” is made. When a random numerical value sampled by the main CPU 41 is 1908 to 2057, a winning combination of “SUN*4” is made. When a random numerical value sampled by the main CPU 41 is 2058 to 2257, a winning combination of “SUN*3” is made.

When a random numerical value sampled by the main CPU 41 is 2258 to 5998, it means a loss, and a losing combination of symbols 180, which is different from any of the above-mentioned winning combinations, is stopped in the display windows 151 to 155. Here, making any of these combinations is referred to as making a win.

[Base Game Payout Table]

Next, a base game payout table 131 will be described with reference to FIG. 6. The base game payout table 131 indicates the number of coins to be paid out and a kind of feature game to be given for a winning combination determined by the base game winning combination lottery table shown in FIG. 5. FIG. 6 shows a base game payout table. The base game payout table 131 is stored in the RAM 43, and read during a game running process which will be detailed later.

For a result of sampling using the base game winning combination lottery table 130, coins are paid out and a feature game is given in accordance with a winning combination displayed in the display windows 151 to 155 based on the base game payout table 131.

More specifically, when five symbols 180 of “HEART” 182 are stopped in the display windows 151 to 155, fifty coins are paid out. When five symbols 180 of “MOON” 183 are stopped in the display windows 151 to 155, thirty coins are paid out as a payout. Likewise, when five symbols 180 of “K” 186 are stopped in the display windows 151 to 155, twenty-five coins are paid out as a payout. When five symbols 180 of “A” 184 are stopped in the display windows 151 to 155, twenty coins are paid out as a payout. When five symbols 180 of “Q” 187 are stopped in the display windows 151 to 155, fifteen coins are paid out as a payout. When five symbols 180 of “J” 185 are stopped in the display windows 151 to 155, ten coins are paid out as a payout. When five symbols 180 of “10” 188 are stopped in the display windows 151 to 155, five coins are paid out as a payout.

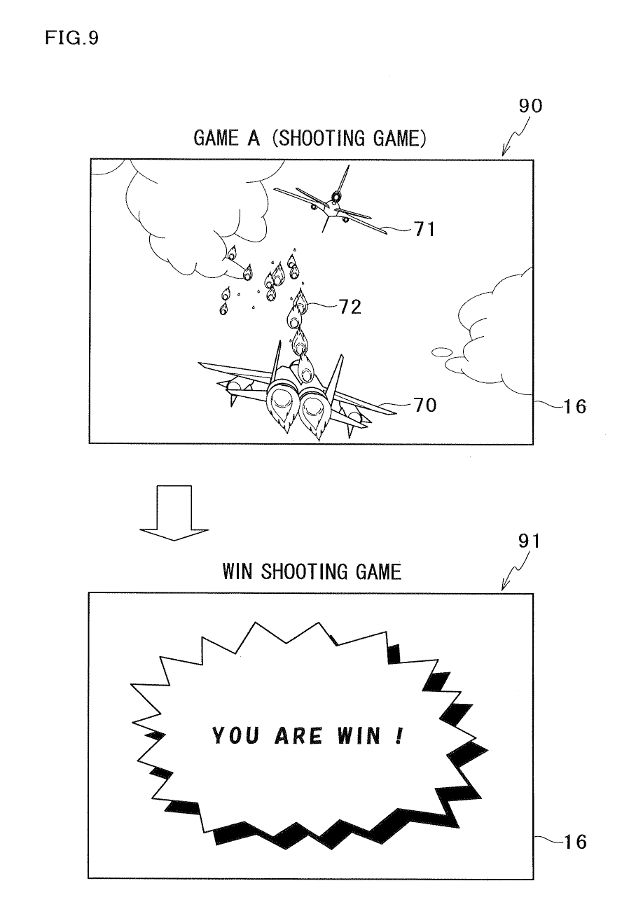

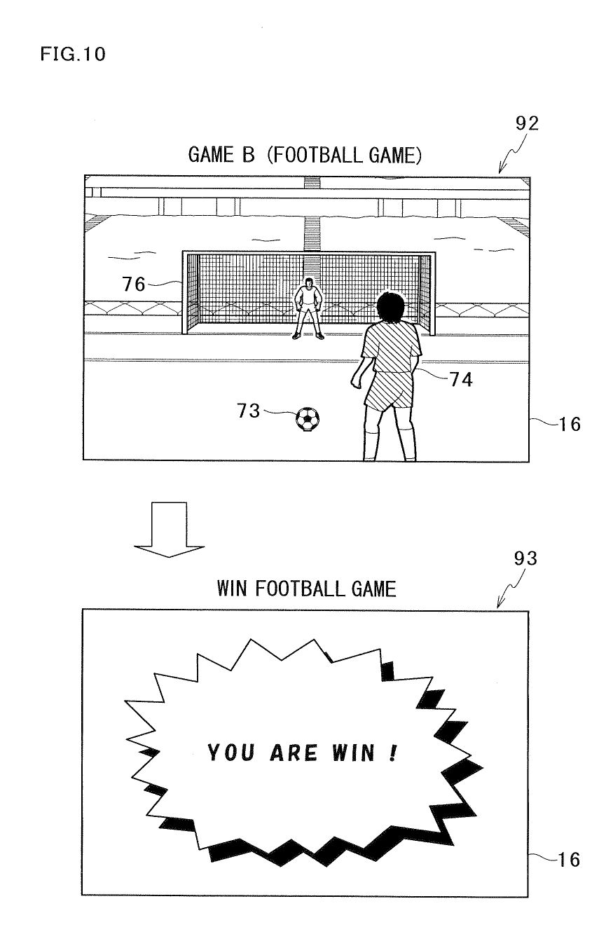

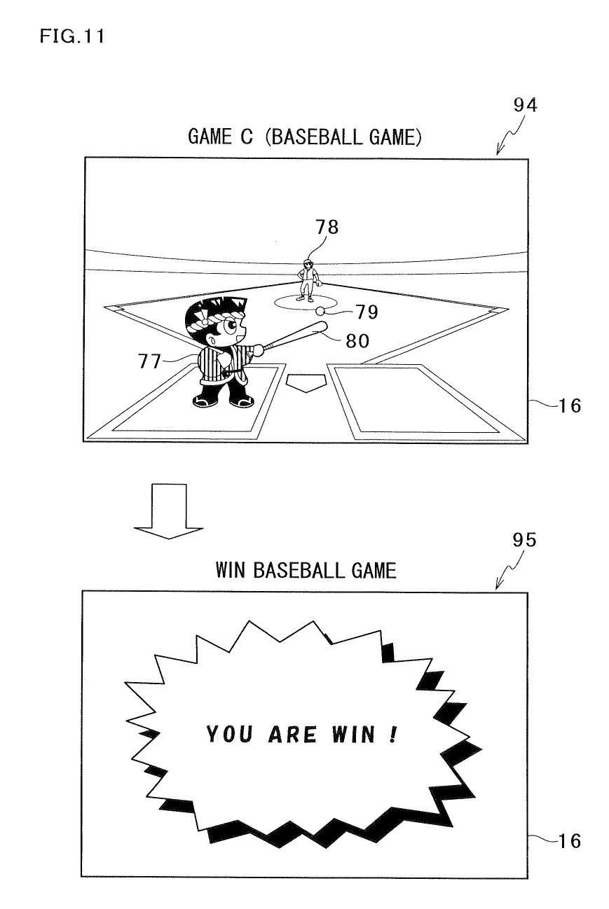

When five symbols 180 of “SUN” 181 are stopped in the display windows 151 to 155, a baseball game of “GAME C” is given as a feature game (see FIG. 11). When four symbols 180 of “SUN” 181 are stopped in the display windows 151 to 155, a football game of “GAME B” is given as a feature game (see FIG. 10). When three symbols 180 of “SUN” 181 are stopped in the display windows 151 to 155, a shooting game of “GAME A” is given as a feature game (see FIG. 9).

When a lottery results in losing, and a losing combination of symbols 180, which is different from any of the above-mentioned winning combinations, is stopped in the display windows 151 to 155, zero coin is paid out as a payout. Note that, when one coin is inserted for a game, the above-mentioned number of coins are paid out as a payout. When two or more coins are inserted for one game, the number of coins actually paid out is the number of inserted coins being multiplied by the above-mentioned number of coins paid out.

[Feature Game Payout Table]

Next, a feature game payout table 133 will be described with reference to FIG. 7. The feature game payout table 133 indicates the number of coins to be paid out when each feature game is won. FIG. 7 shows a feature game payout table. The feature game payout table 133 is stored in the RAM 43, and read during a game running process which will be detailed later.

When each feature game is won, coins are paid out in accordance with a kind of the feature game, based on the feature game payout table 133.

To be more specific, when the “GAME A” (shooting game) is won, fifty coins are paid out as a bonus payout. When the “GAME B” (football game) is won, seventy coins are paid out as a bonus payout. When the “GAME C” (baseball game) is won, one hundred coins are paid out as a bonus payout. When the feature game cannot be won, zero coins are paid out as a bonus payout.

According to the feature game payout table 133 described above, feature games having different expected values of the bonus payout can be given in correspondence with the number of symbols 180 of “SUN” 181 rearranged in the matrix 156 on the display windows 151 to 155. Therefore, for example, by setting a feature game having a higher expected value of the bonus payout as the number of symbols 180 of “SUN” 181 arranged in the matrix 156 on the display windows 151 to 155 increases, a player may enjoy a feature game providing a higher payout in proportion to the number of symbols 180 of “SUN” 181 arranged in the matrix 156 on the display windows 151 to 155. Here, the expected value means an “estimated” payout amount to be given for one feature game.

[Display State of Display Windows 151 to 155 of Gaming Machine]

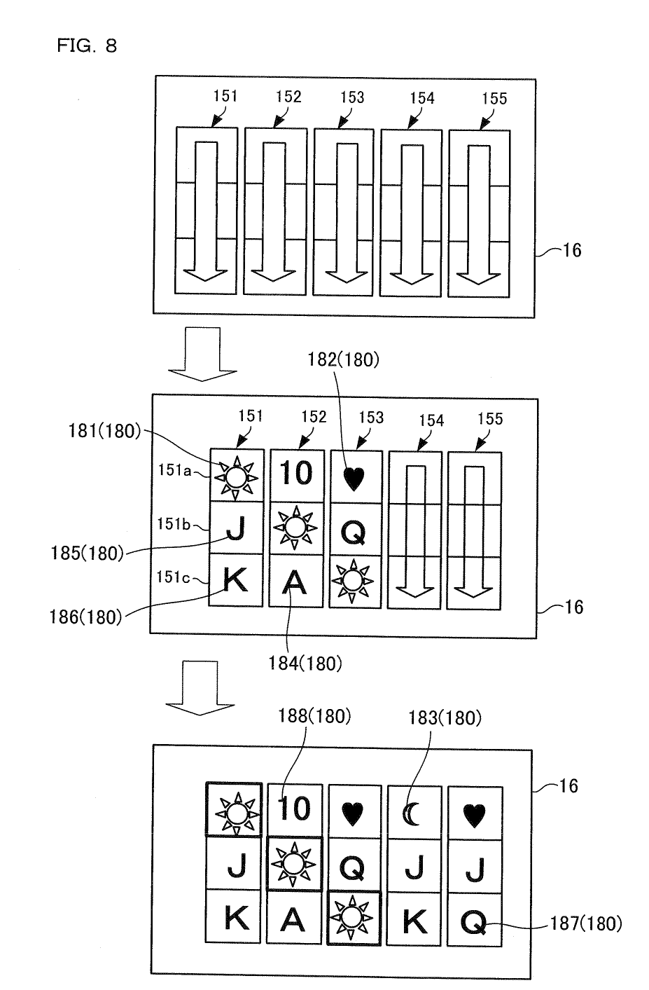

The following details an exemplary display state of the lower image display panel 16 of the gaming machine 1 during operations of the gaming machine 1 and the controlling method thereof. Note that the following example deals with a case where symbols 180 are arranged in the display windows 151 to 155 by means of a video reel method, as shown in FIGS. 1 and 8.

As shown in FIG. 8, the lower image display panel 16 has display windows 151 to 155 where symbols 180 are arranged. The display windows 151 to 155 are disposed at a center part of the lower image display panel 16. In the display windows 151 to 155, symbol columns (symbol lines A to E) each made up of symbols 180 are scrolled (see FIG. 8). The display windows 151 to 155 are respectively divided into a-stages 151a to 155a, b-stages 151b to 155b, and c-stages 151c to 155c. The symbols 180 are stopped (arranged) in the stages 151a to 155a, 151b to 155b, and 151c to 155c, respectively. For example, in FIG. 8, on the lower image display panel 16, a symbol of “SUN” 181 is stopped in the a-stage 151a of the display window 151, a symbol of “J” 185 is stopped in the central stage 151b of the display window 151, and a symbol of “SUN” 181 is stopped in the lower stage 153c of the display window 153. In short, the display windows 151 to 155 displays a matrix 156 as an arrangement region made up of five columns and three rows. The matrix 156 however is not limited to the one with the five-columns/three-rows.

In a basic game (base game), a payout awarding process such as paying out coins is executed when a predetermined number of symbols 181 to 188 called scatter symbols are displayed on the lower image display panel 16 as a winning combination. Scatter symbols are symbols which provide an effective result (such as awarding a payout, giving a bonus game, giving a feature game, or the like) merely when a predetermined number of them are stopped on any of the display areas of the arrangement region made up of five columns and three rows of the display windows 151 to 155. For example, when five symbols of “J” 185, which is one of the scatter symbols shown in FIG. 8, are rearranged (displayed) in the display windows 151 to 155, ten coins are paid out as a payout (see FIG. 6). When five symbols of “HEART” 182, which is one of the scatter symbols, are rearranged (displayed) in the display windows 151 to 155, fifty coins are paid out as a payout (see FIG. 6).

Although in this embodiment the symbols 181 to 188 are defined as scatter symbols, this is not limitative and only a specific symbol may be defined as a scatter symbol. Alternatively, a player may select a scatter symbol. It may also be possible that a coin payout process, a feature game giving process, or the like is executed when a predetermined combination of symbols is stopped on a payline L extending horizontally through the b-stages (151b to 155b) of the display windows 151 to 155. That is, the payline L is for determining a combination of symbols 180. When symbols 180 are rearranged on the payline L and outside the payline L, only the symbols 180 rearranged on the payline are judged for a combination. It may be possible that, when a winning combination is made as a result of the determination of a combination, a coin payout process, a feature game giving process, or the like is executed.

[Display State of GAME A (Shooting Game)]

In this embodiment, an effect display image of the GAME A (shooting game) which is a feature game given during a later-detailed game running process will be described with reference to FIG. 9. An effect image 90 shown in FIG. 9 is displayed on the lower image display panel 16 when a shooting game is executed. The effect image 90 is a shooting game image showing a fighter aircraft 70 seen from a rear side thereof.

In the shooting game run as a feature game, the following effect is presented. That is, by a player's pressing on the button (the 1-BET button 26 or the maximum BET button 27), a missile 72 is launched to an opponent fighter aircraft 71 flying in the screen, so as to hit the missile 72 against the opponent fighter aircrafts 71.

When a missile 72, which is launched by a player's pressing on the button (the 1-BET button 26 or the maximum BET button 27), hits upon the opponent fighter aircraft 71, the player wins the shooting game. Whether the missile 72 hits upon the opponent fighter aircraft 71 or not is determined by lottery which is held every time the button (the 1-BET button 26 or the maximum BET button 27) is pressed. More specifically, when receiving a signal which is transmitted from the 1-BET switch 26S or the BET switch 27S by pressing of the button (the 1-BET button 26 or the maximum BET button 27), the main CPU 41 holds a lottery for determining whether the missile 72 hits the opponent fighter aircraft 71 or not.

When the shooting game is won, an effect image 91 illustrating that the shooting game is won is displayed as shown in FIG. 9. More specifically, letters of “YOU ARE WIN!” are displayed on the lower image display panel 16. This makes the player recognize that he/she wins the GAME A (shooting game) as a feature game. When the GAME A (shooting game) is won, fifty coins are paid out as a bonus payout (see FIG. 7).

[Display State of GAME B (Football Game)]

In this embodiment, an effect display image of the GAME B (football game) which is a feature game given during a later-detailed game running process will be described with reference to FIG. 10. An effect image 92 shown in FIG. 10 is displayed on the lower image display panel 16 when a football game is executed. The effect image 92 is a football game image showing a penalty kick match as seen from a rear side of a kicker 74.

In the football game run as a feature game, the following effect is presented. That is, by a player's pressing on the button (the 1-BET button 26, the spin button 23, or the maximum BET button 27), a ball 73 displayed in the screen is kicked toward a left part, a central part, or a right part of a goal 76, so as to put the ball 73 into the goal 76.

When the ball 73, which is kicked by a player's pressing on the button (the 1-BET button 26, the spin button 23, or the maximum BET button 27), enters the goal 76, the player win the football game. Whether the ball 73 enters the goal 76 or not is determined by lottery which is held every time the button (the 1-BET button 26, the spin button 23, or the maximum BET button 27) is pressed. More specifically, when receiving a signal which is transmitted from the 1-BET switch 26S, the spin switch 23S, or the BET switch 27S by pressing of the button (the 1-BET button 26, the spin button 23, or the maximum BET button 27), the main CPU 41 holds a lottery for determining whether the ball 73 enters the goal 76 or not.

When the football game is won, an effect image 93 illustrating that the football game is won is displayed as shown in FIG. 10. More specifically, letters of “YOU ARE WIN!” are displayed on the lower image display panel 16. This makes the player recognize that he/she wins the GAME B (football game) as a feature game. When the GAME B (football game) is won, seventy coins are paid out as a bonus payout (see FIG. 7).

[Display State of GAME C (Baseball Game)]

In this embodiment, an effect display image of the GAME C (baseball game) which is a feature game given during a later-detailed game running process will be described with reference to FIG. 11. An effect image 94 shown in FIG. 11 is displayed on the lower image display panel 16 when a baseball game is executed. The effect image 94 is a baseball game image showing a batter 77 seen from a rear side thereof.

In the baseball game run as a feature game, the following effect is presented. That is, by a player's pressing on the button (the 1-BET button 26 or the maximum BET button 27), a bat 80 is swung against a ball 79 thrown by a pitcher 78 displayed in the screen, so as to hit the bat 80 upon the ball 79.

When the bat 80, which is swung in accordance with a player's pressing on the button (the 1-BET button 26 or the maximum BET button 27), hits upon the ball 79, the player wins the baseball game. Whether the bat 80 hits upon the ball 79 or not is determined by lottery which is held every time the button (the 1-BET button 26 or the maximum BET button 27) is pressed. More specifically, when receiving a signal which is transmitted from the 1-BET switch 26S or the BET switch 27S by pressing of the button (the 1-BET button 26 or the maximum BET button 27), the main CPU 41 holds a lottery for determining whether the bat 80 hits upon the ball 79 or not.

When the baseball game is won, an effect image 95 illustrating that the baseball game is won is displayed as shown in FIG. 11. More specifically, letters of “YOU ARE WIN!” are displayed on the lower image display panel 16. This makes the player recognize that he/she wins the GAME C (baseball game) as a feature game. When the GAME C (baseball game) is won, one hundred coins are paid out as a bonus payout (see FIG. 7).

[Symbol Column, etc.]

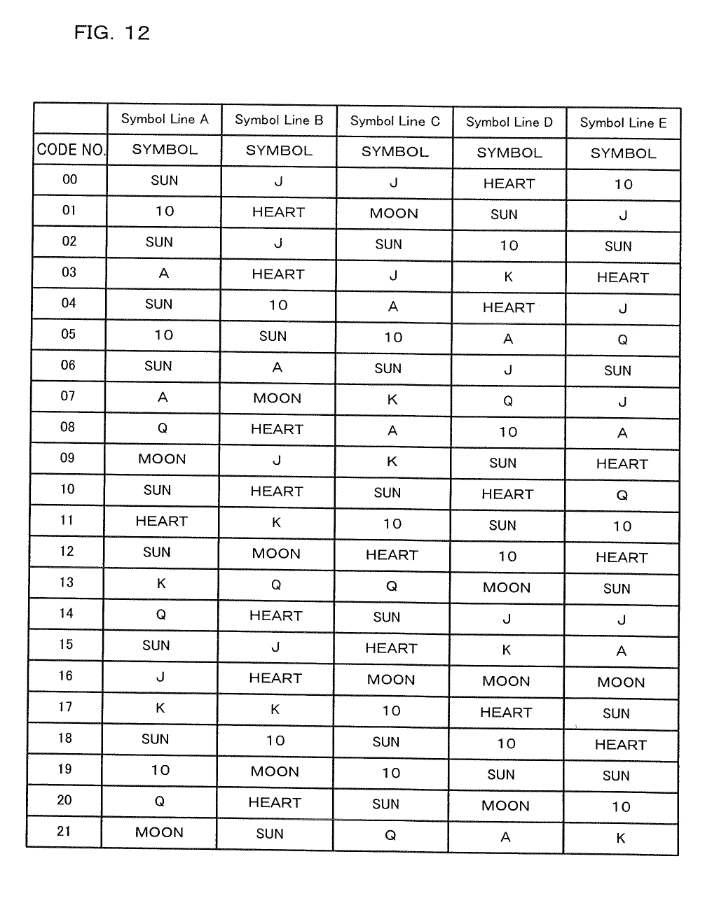

Symbols 180 displayed in the display windows 151 to 155 of the lower image display panel 16 of the gaming machine 1 form five symbol columns (symbol lines A to E) each including twenty-two symbols, as shown in FIG. 12. To each of the symbols 180 constituting the columns is given one of code numbers 00 to 21. Each of the symbol columns has a combination of picture symbols of “SUN” 181, “HEART” 182, and “MOON” 183, and letter symbols 180 of “A” 184, “J” 185, “K” 186, “Q” 187, and “10” 188 (see FIG. 8).

Three successive symbols in the symbol columns are displayed (arranged) in the upper stages 151a, 152a, 153a, 154a, 155a, the center stages 151b, 152b, 153b, 154b, 155b and the lower stages 151c, 152c, 153c, 154c, 155c of the display windows 151 to 155, respectively, to form a matrix of five columns and three rows in the display windows 151 to 155. When a BET button is pushed and then a start button is pushed to start a game, the symbols forming the matrix are scrolled. When a predetermined period of time has elapsed after scroll is started, the scroll of each symbol is stopped (rearranged).

The symbols 181 to 188 are set as scatter symbols. Scatter symbols are such symbols that a player is put into an advantageous position when a predetermined number or more of them are displayed in the display windows 151 to 155. The advantageous position is a state where coins corresponding to the scatter symbols are paid out, a state where the number of coins to be paid out is added to a credit, a state where a bonus game is given, a state where a feature game is given, or the like.

For example, when five symbols of “MOON” 183 are stopped in the display windows 151 to 155, thirty coins (game media) per bet are paid out (see FIG. 6).

In this embodiment, a game value is paid out, a feature game is given, or the like, when a predetermined number of predetermined symbols are stopped in the display windows 151 to 155. However, other privileged games may be given instead. The feature game is a gaming state which is more advantageous than a base game. For example, the feature game is a free game. The free game is a game allowing a player to play a game a predetermined number of times without betting a coin. No particular limitation is put on the feature game, as long as it is a gaming state advantageous to the player, that is, it is more advantageous than the basic game. For example, the feature game may include a state where more game media are obtainable than in the basic game, a state where a game medium is obtainable with higher probability than in the basic game, a state where a game medium is less consumed than in the basic game, and the like. Specifically, a free game, a second game, and the like may be mentioned as examples of the feature game.

[Operation of Gaming Machine]

Next, various processes executed in the gaming machine 1 will be described. As the main CPU 41 reads out and execute programs stored in the ROM 42 and the RAM 43, processes relating to various games are run.

[Operation of Gaming Machine: Boot Process]

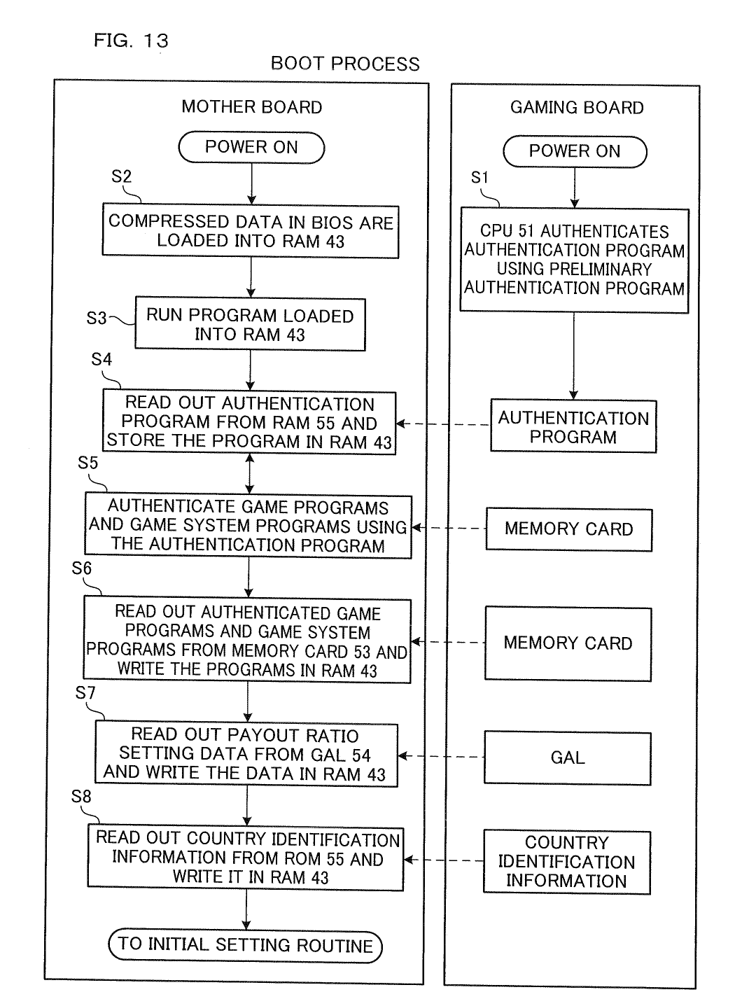

The following describes a boot process which takes place in the gaming machine 1. Upon powering on the power unit 45 of the gaming machine 1, a boot processing routine shown in FIG. 13 starts in the mother board 40 and gaming board 50 in the gaming machine 1. The memory cards 53 is assumed to be inserted into the card slot 53S of the gaming board 50. Further, the GAL 54 is assumed to be attached to the IC socket 54S of the gaming board 50.

First, turning on the power switch of (powering on) the power unit 45 boots the motherboard 40 and the gaming board 50. Booting the motherboard 40 and the gaming board 50 starts separate processes in parallel. Specifically, in the gaming board 50, the CPU 51 reads out a preliminary authentication program stored in the boot ROM 52. Then, preliminary authentication is performed according to the read out program so as to confirm and authenticate that no modification is made to an authentication program, before reading it into the motherboard 40 (S1). Meanwhile, the main CPU 41 of the motherboard 40 runs BIOS stored in the ROM 42 to load into the RAM 43 compressed data built in the BIOS (S2). Then, the main CPU 41 runs a procedure of the BIOS according to the data loaded into the RAM 43 so as to diagnose and initialize various peripheral devices (S3).

The main CPU 41, which is connected to the ROM 55 of the gaming board 50 via a PCI bus, reads out an authentication program stored in the ROM 55 and stores it into the RAM 43 (S4). During this step, the main CPU 41 derives a checksum through ADDSUM method (a standard check function) which is adopted in a standard BIOS, and stores the authentication program into the RAM 43 while confirming if the operation of storing is carried out without an error.

Next, the main CPU 41 checks what connects to the IDE bus. Then, the main CPU 41 accesses, via the IDE bus, to the memory card 53 inserted into the card slot 53S, and reads out game programs and game system programs from the memory card 53. In this case, the CPU 41 reads out four bytes of data constituting the game program and the game system program at one time. Next, in accordance with the authentication program stored in the RAM 43, the CPU 41 authenticates the game program and the game system program read out to confirm and prove that these programs are not modified (S5).

When the authentication properly ends, the main CPU 41 writes and stores the authenticated game programs and game system programs into RAM 43 (S6).

Next, the main CPU 41 accesses, via the PCI bus, to the GAL 54 attached to the IC socket 54S, and reads out data from the GAL 54, respectively. The data read out are then written and stored in the RAM 43 (S7).

Next, the main CPU 41 reads out, via the PCI bus, country identification information stored in the ROM 55 of the gaming board 50. The country identification information read out is then written and stored in the RAM 43 (S8).

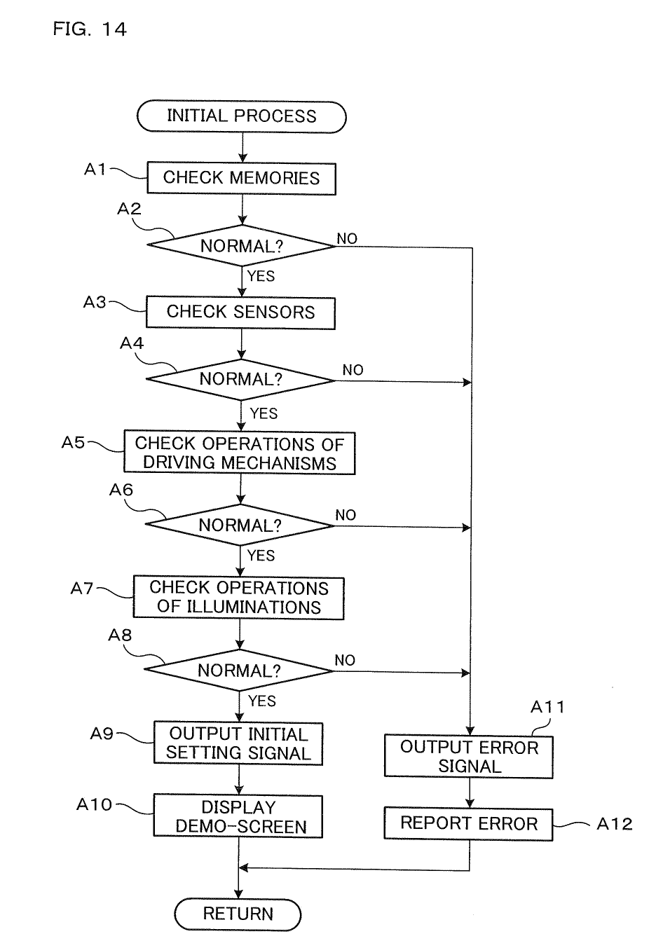

After this, the main CPU 41 performs an initial process shown in FIG. 14.

[Operation of Gaming Machine: Initial Process]

The following describes an initial process which takes place in the gaming machine 1. When the boot process of FIG. 13 is completed, the gaming machine 1 reads out from the RAM 43 an initial processing program illustrated in FIG. 14 and executes the program. FIG. 14 is a flowchart showing procedures of an initial process.

First, the main CPU 41 of the gaming machine 1 checks operations of memories such as the RAM 43 (A1), to determine if all the check results are normal (A2). If the main CPU 41 determines that the check results contain an error (A2: NO), the main CPU 41 outputs a signal notifying the error (hereinafter, error signal) (A11). On the other hand, if the main CPU 41 determines that all the check results are normal (A2: YES), then the main CPU 41 checks operations of various sensors (such as the bill validator 22, the coin counter 21C, and the like) (A3), to determine if all the check results are normal (A4). If the main CPU 41 determines that the check results contain an error (A4: NO), the main CPU 41 outputs an error signal (A11). On the other hand, if the main CPU 41 determines that all the check results are normal (A4: YES), then the main CPU 41 checks operations of driving mechanisms (A5), to determine if all the check results are normal (A6). If the main CPU 41 determines that the check results contain an error (A6: NO), the main CPU 41 outputs an error signal (A11). On the other hand, if the main CPU 41 determines that all the check results are normal (A6: YES), then the main CPU 41 checks operations of illuminations (A7), to determine if all the check results are normal (A8). If the main CPU 41 determines that the check results contain an error (A8: NO), the main CPU 41 outputs an error signal (A11). On the other hand, if the main CPU 41 determines that all the check results are normal (A8: YES), the main CPU 41 outputs an initial setting signal that commands initialization of various peripheral devices (A9).

Then, the main CPU 41 causes the upper image display panel 33 to display a demo-screen informing that checking of operations of the various peripheral devices and setting of initialization have been completed (A10). When the error signal has been output in A11, the main CPU 41 displays a demo-screen on the upper image display panel 33 and lights the lamp 30, to thereby report the error of the various peripheral devices (A12). Then, this process once ends.

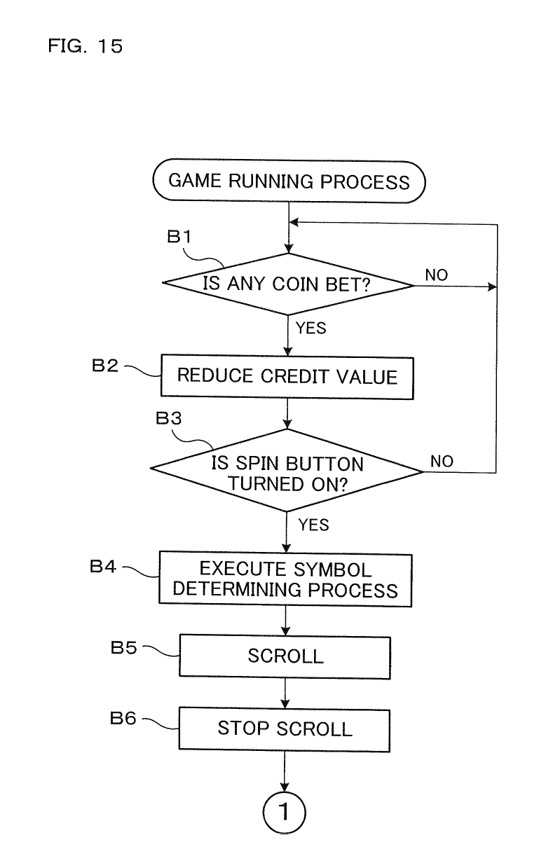

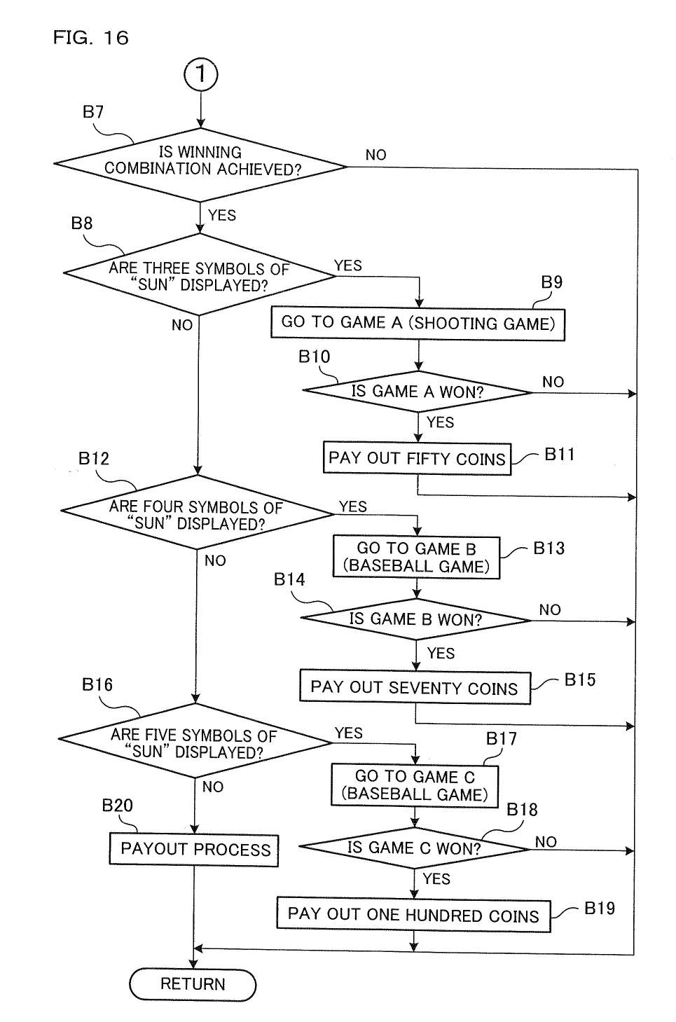

After the above-described process, the main CPU 41 reads out and executes the game program and the game system program sequentially, thereby executing a game running process shown in FIGS. 15 and 16.

[Operation of Gaming Machine: Game Running Process]

After the initial process of FIG. 14, the main CPU 41 of the gaming machine 1 reads out and executes the game program and the game system program sequentially, thereby executing a game running process shown in FIGS. 15 and 16. A game running processing program is stored in the RAM 43.

The main CPU 41 of the gaming machine 1 executes the game running process shown in FIGS. 15 and 16. When the game running process is run, first, the main CPU 41 determines whether a coin is bet or not (B1). In this step, whether an input signal from the 1-BET switch 26S entered by pressing of the 1-BET button 26 is received or not is determined. Meanwhile, whether an input signal from the maximum BET switch 27S entered by pressing of the maximum BET button 27 is received or not is determined. If no coin is BET (B1: NO), the step B1 is repeated so that a standby state continues until a coin is bet.

On the other hand, if it is determined that a coin is bet (B1: YES), the credit value stored in the RAM 43 is reduced according to the number of coins bet (B2). When the number of coins bet surpasses the number of coins equivalent to the credit value stored in the RAM 43, the credit value is reduced to zero and he step B3 is performed. When the number of coins bet exceeds the maximum number of coins bettable on one game (50 pieces in this embodiment), the credit value is reduced by fifty and the step B3 is performed.

Then, whether a spin button 23 is turned on or not is determined (B3). If the spin button 23 is not turned on (B3: NO), the process returns to B1. Here, if the spin button 23 is not turned on (for example, the spin button 23 is not turned on but a command to end the game is input), the reduction of the credit value in B2 is canceled.

On the other hand, when it is determined that the spin button 23 is turned on (B3: YES), a symbol determining process is executed (B4). In other words, a stop symbol determining program is executed based on the base game winning combination lottery table 130 stored in the RAM 43, to determine fifteen symbols 180 to be stopped in the display windows 151 to 155.

Then, symbols 180 in the symbol columns (symbol lines A to E) in the display windows 151 to 155 are scrolled (B5). When a predetermined period of time (base time) has elapsed after the scroll of the symbols 180 is started, the symbols 180 determined in B4 is stopped (rearranged) in the display windows 151 to 155 (B6).

Then, whether a win is made or not, that is, whether a combination of symbols 180 stopped in the display windows 151 to 155 is a winning combination listed in the base game payout table 131 or not, is determined (B7). When it is determined that the combination is not a winning combination (B7: NO), this process ends. When it is determined that the combination is a winning combination (B7: YES), whether three symbols 180 of “SUN” 181 are stopped in the display windows 151 to 155 or not is determined (B8).

When three symbols 180 of “SUN” 181 are stopped in the display windows 151 to 155 (B8: YES), a program for running the “GAME A” (shooting game) as a feature game is read from the RAM 43, and executed (B9). Then, whether the “GAME A” (shooting game) is won or not is determined (B10). When the “GAME A” (shooting game) is not won (B10: NO), this process ends. When the “GAME A” (shooting game) is won (B10: YES), coins corresponding to a kind of the feature game are paid out based on the feature game payout table 133 shown in FIG. 7 (B11). More specifically, when the “GAME A” (shooting game) is won, fifty coins are paid out. Here, for reserving coins to be paid out, a credit value equivalent to the number of coins to be paid out is added to the credit value stored in the RAM 43. On the other hand, for paying out the coins, a control signal is transmitted to the hopper 66 so that a predetermined number of coins are paid out to the coin tray 18. That is, a bonus payout is awarded in accordance with a kind of the feature game. Then, this process ends.

When three symbols 180 of “SUN” 181 are not stopped in the display windows 151 to 155 (B8: NO), then whether four symbols 180 of “SUN” 181 are stopped in the display windows 151 to 155 or not is determined (B12).

When four symbols 180 of “SUN” 181 are stopped in the display windows 151 to 155 (B12: YES), a program for running the “GAME B” (football game) as a feature game is read from the RAM 43, and executed (B13). Then, whether the “GAME B” (football game) is won or not is determined (B14). When the “GAME B” (football game) is not won (B14: NO), this process ends. When the “GAME B” (football game) is won (B14: YES), coins corresponding to a kind of the feature game are paid out based on the feature game payout table 133 shown in FIG. 7 (B15). More specifically, when the “GAME B” (football game) is won, seventy coins are paid out. Here, for reserving coins to be paid out, a credit value equivalent to the number of coins to be paid out is added to the credit value stored in the RAM 43. On the other hand, for paying out the coins, a control signal is transmitted to the hopper 66 so that a predetermined number of coins are paid out to the coin tray 18. That is, a bonus payout is awarded in accordance with a kind of the feature game. Then, this process ends.

When four symbols 180 of “SUN” 181 are not stopped in the display windows 151 to 155 (B12: NO), then whether five symbols 180 of “SUN” 181 are stopped in the display windows 151 to 155 or not is determined (B16).

When five symbols 180 of “SUN” 181 are stopped in the display windows 151 to 155 (B16: YES), a program for running the “GAME C” (baseball game) as a feature game is read from the RAM 43, and executed (B17). Then, whether the “GAME C” (baseball game) is won or not is determined (B18). When the “GAME C” (baseball game) is not won (B18: NO), this process ends. When the “GAME C” (baseball game) is won (B18: YES), coins corresponding to a kind of the feature game are paid out based on the feature game payout table 133 shown in FIG. 7 (B19). More specifically, when the “GAME C” (baseball game) is won, one hundred coins are paid out. Here, for reserving coins to be paid out, a credit value equivalent to the number of coins to be paid out is added to the credit value stored in the RAM 43. On the other hand, for paying out the coins, a control signal is transmitted to the hopper 66 so that a predetermined number of coins are paid out to the coin tray 18. That is, a bonus payout is awarded in accordance with a kind of the feature game. Then, this process ends.

When five symbols 180 of “SUN” 181 are not stopped in the display windows 151 to 155 (B16: NO), a payout process based on the base game is executed (B20). More specifically, the number of coins to be paid out which corresponds to a kind of the winning combination is calculated based on the base game payout table 131 shown in FIG. 6. When coins to be paid out are reserved, a credit value equivalent to the coins is added to the credit value stored in the RAM 43. When the coins are paid out, a control signal is transmitted to the hopper 66 so that a predetermined number of coins are paid out to the coin tray 18. That is, a base payout is awarded in accordance with the winning combination. Then, this process once ends.

In the above-described structure, it is possible to: award a feature game which corresponds to the number of symbols 180 of “SUN” 181 rearranged in the matrix 156 of the display windows 151 to 155; perform the feature game; and award a bonus payout in accordance with a result of the feature game. As a result, which kind of feature game is awarded depends on the number of symbols 180 of “SUN” 181 arranged in the matrix 156 of the display windows 151 to 155. This may allow a player to enjoy the base game with expectation for a plurality of kinds of feature games until symbols 180 are arranged in the matrix 156 of the display windows 151 to 155.

Here, during the game running process, it may also be possible to: randomly change correspondence between a kind of feature game and the number of symbols 180 of “SUN” 181 displayed on the matrix 156 of the display windows 151 to 155; award a feature game corresponding to the number of symbols 180 of “SUN” 181 rearranged in the matrix 156; perform the feature game; and award a bonus payout in accordance with a result of the feature game.

In such a case, a kind of the feature game, which is given based on the number of symbols 180 of “SUN” 181 arranged on the matrix 156 of the display windows 151 to 155, changes every time a base game is executed. A player cannot know which feature game will be executed until the feature game is actually executed. Therefore, the player may enjoy the base game with expectation for a plurality of kinds of feature games.

[Operation of Gaming Machine: Effect Operation]

When the above-described various processes are executed in the gaming machine 1, results or contents corresponding to the processes are, in the form of commands or data, input to respective actuators. For example, when a feature game is executed in each gaming machine 1, the main CPU 41 blinks the lamp 30. In addition, an effect image corresponding to contents of the feature game is displayed on the upper image display panel 33. Moreover, the main CPU 41 performs effect presentation by an audio output from the speaker 29, together with or independently of the effect made on the upper image display panel 33.

In the detailed description provided above, characteristic parts have mainly been described in order that the present invention can be understood more easily. However, the present invention is not limited to the embodiment shown in the detailed description provided above, and may be applied to other embodiments. The scope of application of the present invention should be construed as broadly as possible. Terms and phraseologies adopted in the present specification are for correctly illustrating the present invention, not for limiting. It would be easy for those skilled in the art to derive, from the spirit of the invention described in the present specification, other structures, systems, methods and the like which are included in the spirit of the invention. Accordingly, it should be considered that claims cover equivalent structures, too, without departing from the technical idea of the present invention. An object of the abstract is to enable an intellectual property office, general public institutions, persons belonging to the art but not familiar with patent, legal terms, or technical terms to quickly understand technical contents and essences of the present invention through a simple research. Therefore, the abstract is not intended to limit the scope of the invention that should be evaluated by the claims. In addition, it is desirable to sufficiently refer to already-disclosed documents and the like, in order to fully understand the objects and effects of the present invention.

The detailed description provided above includes a process which is executed on a computer or a computer network. The descriptions and expressions provided above are given for the purpose of allowing those skilled in the art to understand the invention most effectively. In the specification, respective steps used to induce one result, or blocks having a predetermined processing function should be understood as a process having no self-contradiction. In addition, in each step or block, an electrical or magnetic signal is transmitted/received, recorded, and the like. In a process in each step or block, such a signal is embodied in the form of a bit, a value, a symbol, a character, a term, a number, and the like. However, it should be noted that they have been used simply because they are convenient for explanations. A process in each step or block has sometimes been described using an expression which is common to a human behavior. However, in principle, the process described in the specification is executed by a variety of devices. In addition, other structures necessary for each step or block are apparent from the above description.

What is claimed is:

1. A gaming machine comprising:
a display which arranges a plurality of symbols in a matrix of arrangement areas; and
a controller,
wherein the gaming machine performs a base game and a plurality of feature games using the display, and
wherein the controller is programmed to perform the steps of:
(a1) rearranging the plurality of symbols in the arrangement areas in the base game;
(a2) awarding a base payout in accordance with a relation among the symbols rearranged in the arrangement areas;
(a3) awarding a feature game which corresponds to the number of predetermined symbols rearranged in the arrangement areas;
(a4) performing the feature game; and
(a5) awarding a bonus payout in accordance with a result of the feature game.

2. The gaming machine according to claim 1, wherein the controller awards a feature game whose expected value of the bonus payout differs in correspondence with the number of predetermined symbols rearranged in the arrangement areas.

3. A gaming machine comprising:
a display which arranges a plurality of symbols in a matrix of arrangement areas; and
a controller,
wherein the gaming machine performs a base game using the display and a plurality of feature games each corresponding to the number of predetermined symbols arranged in the arrangement areas, and
wherein the controller is programmed to perform the steps of:
(b1) rearranging the plurality of symbols in the arrangement areas in the base game;
(b2) awarding a base payout in accordance with a relation among the symbols rearranged in the arrangement areas;
(b3) randomly changing a correspondence between the number of predetermined symbols and a feature game;
(b4) awarding a feature game which corresponds to the number of predetermined symbols rearranged in the arrangement areas;
(b5) performing the feature game; and
(b6) awarding a bonus payout in accordance with a result of the feature game.

4. The gaming machine according to claim 3, wherein an expected value of the bonus payout which is in accordance with the result of the feature game differs depending on a kind of the feature game.

5. A gaming machine comprising:
a display which arranges a plurality of scatter symbols in a matrix of arrangement areas; and
a controller,
wherein the gaming machine performs a base game and a plurality of feature games using the display, and
wherein the controller is programmed to perform the steps of:
(c1) rearranging the plurality of scatter symbols in the arrangement areas in the base game;
(c2) awarding a base payout in accordance with a relation among the scatter symbols rearranged in the arrangement areas;
(c3) awarding a feature game which corresponds to the number of predetermined scatter symbols rearranged in the arrangement areas;
(c4) performing the feature game; and
(c5) awarding a bonus payout in accordance with a result of the feature game.

6. The gaming machine according to claim 5, wherein the controller awards a feature game whose expected value of the bonus game differs in correspondence with the number of predetermined scatter symbols rearranged in the arrangement areas.

7. A gaming machine comprising:
a display which arranges a plurality of scatter symbols in a matrix of arrangement areas; and
a controller,
wherein the gaming machine performs a base game using the display and a plurality of feature games each corresponding to the number of predetermined scatter symbols arranged in the arrangement areas, and
wherein the controller is programmed to perform the steps of:
(d1) rearranging the plurality of scatter symbols in the arrangement areas in the base game;
(d2) awarding a base payout in accordance with a relation among the scatter symbols rearranged in the arrangement areas;
(d3) randomly changing a correspondence between the number of predetermined scatter symbols and a feature game;
(d4) awarding a feature game which corresponds to the number of predetermined scatter symbols rearranged in the arrangement areas;
(d5) performing the feature game; and
(d6) awarding a bonus payout in accordance with a result of the feature game.

8. The gaming machine according to claim 7, wherein an expected value of the bonus payout which is in accordance with the result of the feature game differs depending on a kind of the feature game.

9. A playing method of a gaming machine which comprises a display for arranging a plurality of symbols in a matrix of arrangement areas, and which performs a base game and a plurality of feature games using the display,
the method including the steps of:
rearranging the plurality of symbols in the arrangement areas in the base game;
awarding a base payout in accordance with a relation among the symbols rearranged in the arrangement areas;
awarding a feature game which corresponds to the number of predetermined symbols rearranged in the arrangement areas;
performing the feature game; and
awarding a bonus payout in accordance with a result of the feature game.
